(19) United States
(12) Patent Application Publication
(10) Pub. No.: US 2026/0075696 A1
(43) Pub. Date: Mar. 12, 2026

(54) METHOD OF TREATING A REFLECTIVE OPTICAL ELEMENT, REFLECTIVE OPTICAL ELEMENT AND OPTICAL ARRANGEMENT

(71) Applicant: Carl Zeiss SMT GmbH, Oberkochen (DE)

(72) Inventors: Olga MERGEL-KUEHN, Aalen (DE); Tina GRABER, Koenigsbronn (DE); Salomé VARGAS RUIZ, Ober-Olm (DE); Martin WEISER, Sinsheim (DE); Stefan WIESNER, Lauchheim (DE); Felix LANGE, Nattheim (DE); Aleksey SIDORENKO, Aalen (DE); Florian SCHAPPER, Neu-Ulm (DE)

(21) Appl. No.: 19/389,693

(22) Filed: Nov. 14, 2025

Related U.S. Application Data
(63) Continuation of application No. PCT/EP2024/063895, filed on May 21, 2024.

(30) Foreign Application Priority Data
May 22, 2023 (DE) 102023204747.0

(51) Int. Cl. H05H 1/26; G02B 5/08

(52) U.S. Cl. CPC H05H 1/26; G02B 5/0891; H05H 2245/42

(57) ABSTRACT

A method treats a reflective optical element for the VUV wavelength range, wherein the optical element has an aluminium surface. Treating the reflective optical element comprises irradiating the reflective optical element with a hydrogen plasma jet for removing an aluminium oxide layer formed on the aluminium surface. A reflective optical element for use in the VUV wavelength range treated by the method can be included in an optical arrangement.

### CROSS-REFERENCE TO RELATED APPLICATIONS

The present application is a continuation of, and claims benefit under 35 USC 120 to, international application No. PCT/EP2024/063895, filed May 21, 2024, which claims benefit under 35 USC 119 of German Application No. 10 2023 204 747.0, filed May 22, 2023. The entire disclosure of each of these applications is incorporated by reference herein.

### FIELD

The disclosure relates to a method of treating a reflective optical element for the VUV wavelength range, having an aluminium surface. The aluminium surface may be formed on an aluminium substrate of the reflective optical element or on an aluminium layer applied to a substrate, for example to a quartz glass substrate. The disclosure also relates to an optical element that is or has been treated by the method, and to an optical arrangement for the VUV wavelength range which includes at least one such optical element.

### BACKGROUND

Reflective optical elements in the form of VUV mirrors for reflection of VUV (“vacuum ultraviolet”) radiation are used for applications including systems for mask inspection or for wafer inspection or in projection exposure apparatuses. Such a VUV mirror generally has a reflectivity of more than 80% in the VUV wavelength range, i.e. at wavelengths between 115 nm and 190 nm. The lifetime desired for such a mirror is more than 10 years. For the desired use, aluminium mirrors have sufficient reflectivity for the VUV radiation. However, the stability of aluminium mirrors is relevant since these undergo significant oxidation when exposed to ambient air and irradiated with short-wave radiation, which can lead to a decrease in VUV reflectivity of up to 80%.

In order to increase the stability of the mirror or aluminium surface and to prevent oxidation, there have been various proposals to use protective layers of metal fluorides (e.g. LiF, MgF₂, AlF₃) that have comparatively low absorption and are applied to the aluminium surface.

Examples of such protective layers are described inter alia in the article “Reflecting coatings for the extreme ultraviolet”, G. Hass & R. Tousey, JOSA, 49 (6), 593-602 (1959), in the article “Performance and prospects of far ultraviolet aluminum mirrors protected by atomic layer deposition”, J. Hennessy et al., Journal of Astronomical Telescopes, Instruments, and Systems, 2 (4), 041206, and in the article “Atomic layer deposition and etching methods for far ultraviolet aluminum mirrors”, J. Hennessy et al., in Astronomical Optics: Design, Manufacture, and Test of Space and Ground Systems (Vol. 10401, p. 1040119), Int. Society for Optics and Photonics.

In these articles, protective layers of metal fluorides serve as a barrier to oxidizing species such as water and oxygen, in order to prevent the oxidation of the aluminium surface under operating conditions. The latter article proposes removing a native aluminium oxide layer on a mirror by atomic layer etching and subsequently applying a metal fluoride layer by atomic layer deposition.

It is also possible to protect an aluminium surface by applying a protective layer prior to degradation or prior to oxidation that is not formed from a metal fluoride. For example, such a protective layer may contain silicon or carbon or consist of silicon or of carbon. The protective layer serves to passivate the aluminium and is removed prior to use of the reflective optical element.

In the irradiation of VUV mirrors under different ambient conditions, even if a protective layer was present, degradation was observed, which resulted in a significant reduction in reflectivity of the VUV mirror.

The article “Plasma-assisted deposition of metal fluoride coatings and modeling the extinction coefficient of as-deposited single layers”, M. Bischoff et al., Appl. Opt. 50, 232-238 (2010) describes the aftertreatment of metal fluoride layers that have been deposited by plasma-assisted electron beam deposition by irradiation with UV radiation.

The article states that this aftertreatment can increase the initially poor transmission of LaF₃, MgF₂ and AlF₃ layers in the DUV wavelength range.

### SUMMARY

The disclosure seeks to provide a method of treating a reflective optical element in order to stabilize or to improve the optical properties thereof.

In embodiments, the disclosure provides a method, in which treating of the reflective optical element comprises irradiating an optical element with a hydrogen plasma jet for removing an aluminium oxide layer formed on the aluminium surface.

A native layer of aluminium oxide (Al₂O₃) can be formed relatively quickly on an aluminium surface on contact with ambient air. Irradiating the reflective optical element with VUV radiation during operation thereof in an optical arrangement typically leads to an increase in the thickness of the native aluminium oxide layer with increasing duration of the irradiation.

The inventors have found that with the aid of a hydrogen plasma jet, the aluminium oxide layer is removed or reduced to metallic aluminium, so as to form an exposed aluminium surface. The hydrogen plasma jet contains reactive hydrogen species, for example in the form of atomic hydrogen or of hydrogen radicals, and in the form of hydrogen in an excited electronic state, which reduce the aluminium oxide in the aluminium oxide layer and remove the aluminium oxide layer.

In a variant, the hydrogen plasma jet contains at least one carrier gas selected from the group comprising: N₂ and Ar. The reactive species that are generated by a plasma source are typically taken up in a carrier gas and directed in the form of the hydrogen plasma jet onto the aluminium surface. The use of N₂ and/or Ar as a carrier gas has been proven to be desirable for this purpose.

In a variant, removing the aluminium oxide layer is followed by irradiating the exposed aluminium surface with a fluorine plasma jet. The reactive species that are generated by a plasma source are typically taken up in a carrier gas and directed in the form of the fluorine plasma jet onto the aluminium surface.

The inventors have recognized that irradiating the reflective optical element, more specifically of the aluminium surface, with a fluorine plasma jet can improve the optical properties of the optical element. For example, irradiation with the fluorine plasma jet can increase the reflectivity of the optical element when it has been irradiated with VUV radiation over a prolonged period and/or when it has been exposed to an oxygen-containing environment. The treatment with the fluorine plasma jet can regenerate the reflective optical element for example after irradiation with VUV radiation over a prolonged period of time. In some cases, the treatment can restore the reflectivity of the optical element prior to irradiation with the VUV radiation.

The proposed treatment of the reflective optical element with a fluorine plasma jet means that the treatment can be performed relatively rapidly, and only relatively minor technical prerequisites are involved for implementation thereof.

In one development of a variant of the method, irradiating with the fluorine plasma jet forms an aluminium fluoride layer on the aluminium surface. In this case, the irradiation can comprise two steps that typically proceed successively. In the first step, with the aid of a hydrogen plasma jet, the aluminium oxide layer is removed or reduced to metallic aluminium, so as to form an exposed aluminium surface. In the second step, the aluminium at the exposed surface is oxidized by the reactive fluorine species of the fluorine plasma jet in order to form the passivating aluminium fluoride layer.

Irradiating the aluminium surface with the fluorine plasma jet can oxidize the metallic aluminium on the aluminium surface and can form aluminium fluoride, for example according to the following chemical reaction equation:

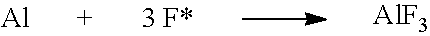

where F* denotes a reactive fluorine species, e.g. a fluorine radical, present in the fluorine plasma jet. As described above, a metal fluoride layer in the form of an aluminium fluoride layer may serve as a barrier for oxidizing species such as water and oxygen, in order to prevent oxidation of the aluminium surface under operating conditions. A protective layer of AlF₃ can have a comparatively low absorption for VUV radiation. Irradiating the aluminium surface of the reflective optical element with the fluorine plasma jet can produce the AlF₃ layer in a relatively simple manner.

As described above, forming the aluminium fluoride layer can be preceded by removing a (native) aluminium oxide layer formed on the aluminium surface. If the aluminium surface is not protected in some other way (see below), it is desirable to remove the native aluminium oxide layer before the aluminium fluoride layer can be formed on the aluminium surface. There are other options for the removing of the aluminium oxide layer than by irradiating the reflective optical element with a hydrogen plasma jet.

For example, the aluminium oxide layer can be removed by irradiating the aluminium oxide layer with the fluorine plasma jet and converting it at least partly to the aluminium fluoride layer. It is possible to remove an aluminium oxide layer by reactive etching with a fluorine plasma jet; cf., for example, the article “Chemical sputtering of Al₂O₃ by fluorine-containing plasmas excited by electron cyclotron resonance”, Y. H. Lee et al., Journal of Applied Physics 68, 5329 (1990), which is incorporated into this application in its entirety by reference. The article describes reactive ion etching of aluminium oxide (Al₂O₃) by CHF₃ and SF₆ plasmas that are generated by electron cyclotron resonance. This states that the lack of volatility of the etching products generated in the etching of aluminium oxide by chemical reactions alone mean that the etching products cannot be desorbed at room temperature. It is therefore stated therein that ion bombardment is used to etch Al₂O₃ by chemically enhanced physical sputtering. Bombarding the aluminium oxide layer with reactive fluorine species, for example with fluorine ions, is effected in the irradiation of the aluminium oxide layer using the fluorine plasma jet.

The article “Advances in precision freeform manufacturing by plasma jet machining”, T. Arnold et al., EPJ Web Conf. 238, 2020, which is incorporated into this application in its entirety by reference, describes producing precise freeform optics by plasma jet machining at atmospheric pressure. Because of the exclusively chemical mechanism of material removal, which is based on a dry etching process using a fluorine-containing gas, there is a limited selection of materials that can be machined by plasma jet machining. The above-cited article and the thesis “Investigation on Reactivity Driven Etching Mechanism in Plasma Jet-based Precision Surface Machining of Borosilicate Crown optical Glass”, F. Kazemi, Leibnitz Institute of Surface Engineering (IOM), 2020, state that machining of borosilicate crown glass in which the etching gives rise to a residual layer is also possible by reactive plasma jet machining. The plasma jet machining described in the article and in the thesis can be used to remove the aluminium oxide layer.

If the fluorine plasma jet is used for the removing of the aluminium oxide layer, the treatment can be effected in a single step in which the reactive fluorine species of the fluorine plasma jet first remove the aluminium oxide layer by reactive etching and subsequently form the passivating protective layer of aluminium fluoride. The plasma parameters are typically chosen here such that there is firstly reactive etching of the aluminium oxide layer, i.e. removal of the aluminium oxide layer. Different plasma parameters that do not cause material removal are generally established for forming the aluminium fluoride layer.

If suitable plasma parameters are established in the irradiation, the following chemical reaction may also proceed in the aluminium oxide layer:

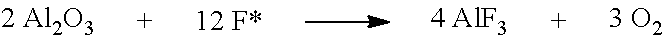

where F* denotes a reactive fluorine species. In this case, the aluminium oxide layer is at least partly removed in that it is converted to the aluminium fluoride layer. In this case, it is possible to remove the aluminium oxide layer and form the aluminium fluoride layer without having to alter the plasma parameters in the irradiation with the fluorine plasma jet.

In a variant, forming the aluminium fluoride layer is preceded by removing a protective layer applied to the aluminium surface. The protective layer is not the (native) aluminium oxide layer described above, but instead a specially applied protective layer intended to protect the aluminium surface from the formation of the native aluminium oxide layer for example. The material of the protective layer is to be chosen such that it can be removed in a relatively simple manner.

In one development of a variant, the protective layer is formed from at least one material that forms a volatile fluorine species in conjunction with fluorine. A protective layer of such a material can be removed in a relatively simple manner, for example using a fluorine plasma jet.

The protective layer may be formed, for example, from silicon or from carbon. These materials can prevent the formation of the native aluminium oxide layer on the aluminium surface and can be more easily removed from the aluminium surface than the aluminium oxide layer.

In one development, the protective layer is removed by irradiating with the fluorine plasma jet. In this case, the fluorine species of the fluorine plasma jet can etch the material of the protective layer, for example Si or C, and can lead to the formation of volatile species, for example of SiF₄ or of CF₄. In order to increase the etch rate, for example by the additional formation of CO₂, it is possible to add oxygen to the fluorine plasma jet or to irradiate with the fluorine plasma jet in an environment in which oxygen is present. In this development too, irradiating with the fluorine plasma jet can form the aluminium fluoride layer on the aluminium surface subsequently, i.e. after the removal of the protective layer, by the oxidation of the metallic aluminium.

In a variant, a protective layer of at least one metal fluoride that is applied to the aluminium surface is irradiated with the fluorine plasma jet for post-fluorination. In this case, differently from the description above, rather than formation of an aluminium fluoride layer on irradiation with the fluorine plasma jet, there is instead post-fluorination of an existing metal fluoride layer, for example an LiF layer, an MgF₂ layer or an AlF₃ layer. It will be apparent that the protective layer in the form of the aluminium fluoride layer can be produced, for example, with the aid of the variant of the method described above or else using a thermal evaporation process.

In the irradiation of a reflective optical element with VUV radiation under different ambient conditions, significant photon-induced damage to protective layers in the form of metal fluorides (formation of colour centres and oxidation) was detected. The damage may continue up to the aluminium surface, which forms the interface between the protective layer of the metal fluoride and the substrate composed of aluminium or the aluminium layer, such that the functionality of the aluminium mirror may be completely lost.

The inventors have recognized that the optical properties of the reflective optical element can be regenerated or maintained after irradiation with VUV radiation when the protective layer of the at least one metal fluoride is irradiated with a fluorine plasma jet. This exploits the fact that the active fluorine species in the fluorine plasma, for example in the form of fluorine radicals, can convert metal oxides formed in the protective layer in the VUV irradiation to metal fluorides and also satisfy or eliminate colour centres that have formed during the VUV irradiation. The conversion of the metal oxides to metal fluorides generally increases the reflectivity of the reflective optical element since the metal fluorides used for the protective layer generally have lower absorption for VUV radiation than the corresponding metal oxides.

Both processes, i.e. the conversion of the metal oxides to metal fluorides and the elimination of the colour centres by the active fluoride species can lead to an increase in VUV reflectivity of the reflective optical element to up to 80%, which can help ensure the functionality of the reflective optical element for the desired use. In the treatment with the fluorine plasma jet, it is additionally possible to convert aluminium oxide formed at the aluminium surface to aluminium fluoride, which likewise leads to an increase in reflectivity.

In a variant, the treatment is preceded by irradiating the reflective optical element with VUV radiation. Irradiating with the VUV radiation is typically effected during operation of an optical arrangement into which the reflective optical element is integrated. As described above, irradiating with VUV radiation can lead to degradation processes, for example in the protective layer including at least one metal fluoride, but also to an increase in the thickness of a (native) aluminium oxide layer, which reduce the reflectivity of the optical element. It is favourable or advisable to conduct the treatment of the reflective optical element from time to time, such as periodically, after a particular duration of irradiation with VUV radiation. Alternatively, it is possible to monitor the reflectivity of the optical elements for VUV radiation and to conduct the treatment when the reflectivity goes below a threshold value.

The fluorine plasma jet is generated by a plasma source, which may, for example, be a high-frequency plasma source or a microwave plasma source. The treatment is typically conducted in a process chamber in which the reflective optical element for the treatment is disposed. It is desirable that other components disposed in the process chamber are compatible with fluorine-containing gases, i.e. are not attacked by the reactive fluorine.

In one variant, the hydrogen plasma jet and/or the fluorine plasma jet is/are moved across the aluminium surface in the course of treatment of the reflective optical element. For the treatment, it may be insufficient for the hydrogen plasma jet and/or the fluorine plasma jet to be aligned only to one position, for example in the centre of the aluminium surface.

Instead, it has been found to be desirable for the hydrogen plasma jet and/or the fluorine plasma jet to be moved across the aluminium surface. In order to allow this, the plasma treatment system into which the reflective optical element is introduced for the treatment may have a position control system. It is also favourable when the plasma treatment system has a temperature monitoring or control system in order to monitor or control the temperature in the process chamber. It has also been found that a detection system for detection of fluorine gas (F₂) or a safeguarding system for avoidance of escape of fluorine gas from the process chamber is favourable.

Moving the hydrogen plasma jet and/or of the fluorine plasma jet across the surface of the aluminium surface can allow for a spatially resolved treatment of the reflective optical element by varying the time duration in which the hydrogen/fluorine plasma jet is directed to a respective location of the surface. In this way, the thickness of the aluminium oxide layer that is removed by the hydrogen plasma jet can be varied locally across the surface. Moreover, the fluorination of the aluminium surface by the fluorine plasma jet and thus the thickness of the aluminium fluoride layer that is formed on the aluminium surface can be varied locally across the surface.

It is possible to generate a radial variation of the fluorination by the fluorine plasma jet by varying the time duration of the irradiation of the aluminium surface by the fluorine plasma jet in a radial manner. In this way, an aluminium fluoride layer with a radially varying thickness distribution can be formed on the aluminium surface. An aluminium fluoride layer having such a radially varying thickness distribution can be used as a grey filter with a radially varying filter profile. A grey filter of this kind may be used e.g. for generating or for compensating apodization effects. It will be understood that the time duration of the fluorination by the fluoride plasma jet and/or of the reduction by the hydrogen plasma jet may alternatively by varied across the surface in a non-rotationally symmetric manner.

In a variant, treating the reflective optical element is conducted under vacuum conditions. The proposed process for treatment of the reflective optical element does not necessarily require performance under vacuum conditions. However, it has been found to be favourable to conduct the treatment with the fluorine plasma jet under vacuum conditions in order to have better control over the environment and to reduce the risk of surface contamination. The same applies to the treatment with the hydrogen plasma jet.

In a variant, the fluorine plasma jet contains at least one reactive gas selected from the group comprising: CF₄, CHF₃, C₂F₆, NF₃, SF₆ and F₂. It will be apparent that other reactive gases may also be present in the plasma jet, e.g. XeF₂, XeF₄, XeF₆, etc. The reactive gas is excited in the plasma source in order to generate reactive fluorine gas species, for example in the form of fluorine radicals, fluorine ions or fluorine in an excited electronic state. It is also possible to add a small proportion of oxygen (O₂) to the fluorine plasma jet in order to increase the etch rate, for example when a protective layer of a material that forms a volatile species in conjunction with oxygen is to be removed. This is the case, for example, for a protective layer of carbon since carbon forms volatile CO₂ with oxygen.

In a variant, the fluorine plasma jet contains at least one carrier gas, such as a gas selected from the group comprising: N₂, He and Ar. The reactive species that are generated by the plasma source are typically taken up in a carrier gas and directed in the form of the fluorine plasma jet onto the aluminium surface or onto the protective layer. The carrier gas is generally an inert gas, for example nitrogen or a noble gas, for which it is possible to use not only He and Ar, but optionally also Ne and Kr.

Because of the relatively high reactivity of the active fluorine species, the proposed treatment is relatively stable and robust within a relatively wide range of plasma conditions. These plasma conditions include, for example: gas flow rate of the plasma jet, process chamber pressure, power of the plasma source, distance between the plasma source and the aluminium surface, treatment time, temperature, etc.

Further features and aspects of the disclosure are apparent from the description that follows, with reference to the figures, which show certain details of the disclosure, and from the claims. The individual features can be implemented individually in their own right or collectively in any combination in a variant of the disclosure.

### BRIEF DESCRIPTION OF THE DRAWINGS

The figures show:

FIGS. 1A-1B schematic diagrams of a mirror for the VUV wavelength range with an exposed aluminium surface on and after irradiation with VUV radiation;

FIGS. 2A-2B schematic diagrams of the mirror from FIG. 1A-1B during and after treatment with a fluorine plasma jet to form an aluminium fluoride layer;

FIGS. 3A-3C schematic diagrams of the mirror of FIGS. 1A-1B during treatment with a hydrogen plasma jet and during and after treatment with a fluorine plasma jet;

FIGS. 4A-4B schematic diagrams of a mirror for the VUV wavelength range with a protective layer during and after treatment with a fluorine plasma jet to form an aluminium fluoride layer;

FIGS. 5A-5B schematic diagrams of a mirror for the VUV wavelength range with a protective layer of a metal fluoride during and after irradiation with VUV radiation;

FIGS. 6A-6B schematic diagrams of the mirror from FIG. 5A-5B during and after treatment with a fluorine plasma jet for post-fluorination of the protective layer;

FIG. 7 a schematic diagram of an optical arrangement for the VUV wavelength range in the form of a VUV lithography apparatus; and

FIG. 8 a schematic diagram of an optical arrangement for the VUV wavelength range in the form of a wafer inspection system.

### DETAILED DESCRIPTION

In the description of the drawings that follows, identical reference signs are used for components that are the same or have the same function.

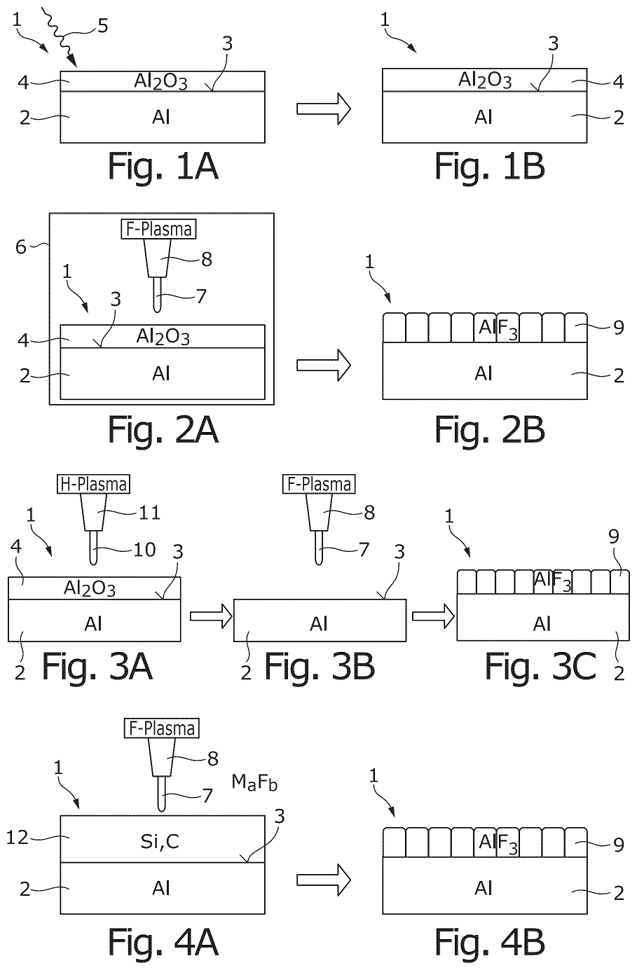

FIGS. 1A, 1B show schematic diagrams of a reflective optical element for the VUV wavelength range in the form of a mirror 1. The mirror 1 has a substrate 2 of aluminium, having an aluminium surface 3 that serves as mirror surface. As apparent in FIG. 1A, the reflective optical element 1 is hit during operation in an optical arrangement by VUV radiation 5, which is reflected at the aluminium surface 3 of the mirror 1. The reflective aluminium surface 3 may alternatively be formed on an aluminium layer applied to a substrate, for example of quartz glass or of another material. As apparent in FIG. 1A, a native aluminium oxide layer 4 has been formed on the aluminium surface 3.

FIG. 1B shows the mirror 1 after a defined period of irradiation with the VUV radiation 5. As apparent in FIG. 1B, the irradiation with the VUV radiation 5 has increased the thickness of the aluminium oxide layer 4. In order to increase the reflectivity of the mirror 1 after irradiation with VUV radiation 5 to the value of about 80% for use in a wafer inspection system for example, the mirror 1, after a defined period of irradiation with the VUV radiation 5, is introduced into a process chamber 6 and subjected to a treatment with a fluorine plasma jet 7, as shown in FIG. 2A. The treatment with the fluorine plasma jet 7 can be performed periodically whenever a particular duration of irradiation with the VUV radiation 5 within the optical arrangement is attained. It may also be possible to conduct the treatment with the fluorine plasma jet 7 whenever the reflectivity of the mirror 1 goes below a threshold value.

In the treatment of the mirror 1 with the fluorine plasma jet 7, the latter is directed onto the aluminium surface 3 of the mirror 1 and moved across the surface 3 with the aid of a position control system (not shown pictorially). The fluorine plasma jet 7 is generated by a plasma source 8, which may, for example, be an RF plasma source or a microwave plasma source. The fluorine plasma jet 7 is a gas jet in which reactive fluorine species are present in an inert carrier gas, e.g. N₂, He or Ar, Ne, Kr, etc. The reactive fluorine species, for example in the form of fluorine radicals, are produced from a reactive fluorine gas in the plasma source 8. The reactive fluorine gas may, for example, be a gas selected from the group comprising: CF₄, CHF₃, C₂F₆, NF₃, SF₆ and F₂. Also possible are fluorine-containing gases such as XeF₂, XeF₄, XeF₆, etc. It is also possible to add oxygen (O₂) to the fluorine plasma jet 7.

The power of the plasma source 8 and other plasma parameters may be adjusted such that the aluminium oxide layer 4 is firstly removed by reactive (ion) etching, as described in the articles cited above or in the thesis by F. Kazemi. After the removal of the aluminium oxide layer 4, it is possible using the fluorine plasma jet 7 to oxidize the metallic aluminium at the aluminium surface 3, in order to form an aluminium fluoride layer 9 as shown in FIG. 2B.

Alternatively, the plasma parameters can be adjusted such that, in the course of irradiation with the fluorine plasma jet 7 in the aluminium oxide layer 4, the following chemical reaction proceeds:

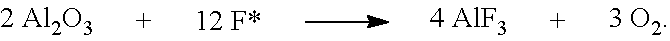

In the above reaction equation, F* denotes a reactive fluorine species.

The treatment with the fluorine plasma jet 7 in this case converts the aluminium oxide layer 4 to the aluminium fluoride layer 9 shown in FIG. 2B. The aluminium fluoride layer 9 forms a passivating protective layer and has distinctly lower absorption for the VUV radiation 5 than the aluminium oxide layer 4. The mirror 1 after the treatment, as shown in FIG. 2B, has sufficient reflectivity in order to be introduced (possibly reintroduced) into an optical arrangement and to be operated therein.

As described above, the treatment with the fluorine plasma jet 7 is effected in the process chamber 6 shown in FIG. 2A. In the example shown, the treatment is effected under vacuum conditions in order to minimize the risk of surface contamination. It is alternatively possible to conduct the treatment with the fluorine plasma jet 7 in the process chamber 6 at higher pressures, for example at atmospheric pressure.

The components present in the process chamber 6 withstand the attack of reactive fluorine species or of fluorine gas. Monitoring of the process chamber 6 for escaping fluorine gas or corresponding safety checking is generally likewise desirable. The temperature in the process chamber 6 should also be monitored and, if desired, adjusted or regulated.

FIGS. 3A-3C show an alternative approach for treating the mirror 1 from FIG. 1A for restoration of its reflectivity. In this treatment, in a first step shown in FIG. 3a, the aluminium oxide layer 4 is irradiated with a hydrogen plasma jet 10 in order to remove it from the aluminium surface 3. The hydrogen plasma jet 10 is a gas jet in which reactive hydrogen species are present in an inert carrier gas, e.g. N₂, He or Ar, Ne, Kr, etc. The reactive hydrogen species are generated in the further plasma source 11, for example in that molecular hydrogen is moved past a heated filament. It will be apparent that the aluminium oxide layer 4 can also be removed from the aluminium surface 3, if appropriate, in a different way than with the aid of the hydrogen plasma jet 10.

In a second step of the treatment of the mirror 1, as shown in FIG. 3B, the exposed aluminium surface 3 is irradiated with the fluorine plasma jet 7, as described in association with FIG. 2A. The metallic aluminium at the surface 3 is oxidized here to aluminium fluoride, in which case, for example, the following chemical reaction can proceed:

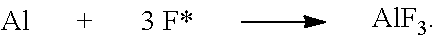

After the treatment described in FIGS. 3A-3B, the reflective optical element 1 has a passivating aluminium fluoride layer 9 (cf. FIG. 3C) and can be used in an optical arrangement. The treatment with the hydrogen plasma jet 10 and with the fluorine plasma jet 7 can be effected in one and the same process chamber 6, but it is also possible that the treatment is conducted in two different process chambers or in two different plasma treatment systems.

By varying the time duration in which the fluorine plasma jet 7 is directed to a specific location of the exposed aluminium surface 3, a passivating aluminium fluoride layer 9 with a location-dependent thickness profile can be obtained. For instance, when the time duration of the irradiation with the fluorine plasma jet 7 is varied in a rotationally-symmetric manner, a passivating aluminium fluoride layer 9 with a rotationally-symmetric thickness profile can be generated. Such a rotationally-symmetric thickness profile can be used e.g. as a grey filter to produce or to compensate apodization effects.

FIGS. 4A-4B show the treatment of a mirror 1 for the VUV wavelength range, in which a dedicated protective layer 12 consisting of at least one material M that forms a volatile fluorine species MₐF_{b} with fluorine F is applied to the aluminium surface 3. The protective layer 12 may consist, for example, of silicon or of carbon. The protective layer 12 has been deposited in a preceding step (not shown pictorially) in the process chamber 6 using a conventional coating method immediately after the deposition of the aluminium on the aluminium surface 3, in order to prevent the formation of a native aluminium oxide layer.

As shown in FIG. 4A, the protective layer 12 is removed by reactive etching using a fluorine plasma jet 7, and the aluminium fluoride layer 9 shown in FIG. 4B is formed simultaneously or subsequently. In the treatment of the protective layer 12 of silicon as shown in FIG. 4A, for example, the following chemical reactions may proceed:

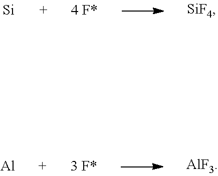

SiF₄ is a volatile fluoride that does not remain on the aluminium surface 3, such that the protective layer 12 of silicon is removed with the aid of the fluorine plasma jet 7 until the aluminium surface 3 is exposed. Correspondingly, in the case of the protective layer 12 composed of carbon too, irradiation with a fluorine plasma jet 7 forms volatile CF₄. In the irradiation, oxygen may additionally be added as a reactive gas in order to promote the formation of volatile CO₂ and to increase the etch rate. The carbon is removed until the aluminium surface 3 is exposed. The reaction of the metallic aluminium at the exposed aluminium surface 3 with the activated fluorine species in the fluorine plasma jet 7 forms the passivating aluminium fluoride layer 9 on the mirror 1 as shown in FIG. 4B.

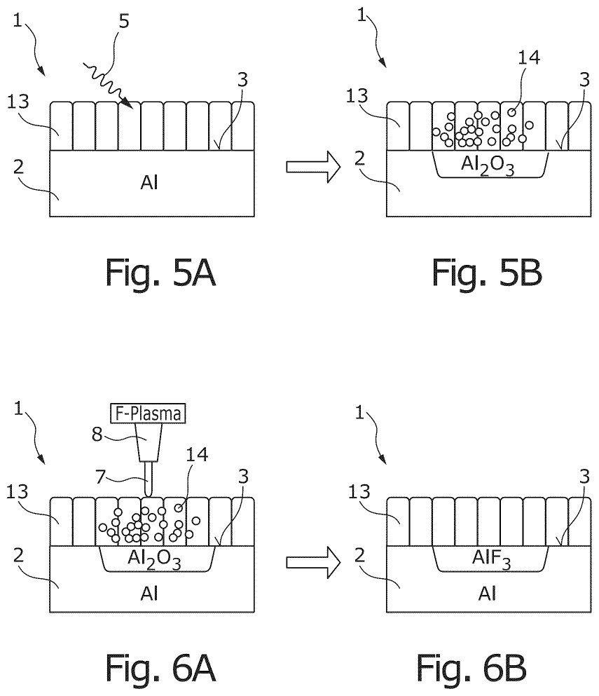

FIGS. 5A-5B show a mirror 1 where, by contrast with the mirror 1 shown in FIGS. 1A-1B, the irradiation with VUV radiation 5 was preceded by application of a protective layer 13 in the form of a metal fluoride layer. The metal fluoride may be, for example, LiF, MgF₂ or AlF₃. If the metal fluoride is AlF₃, the protective layer 13 may have been formed by the treatment of the mirror 1 described above and may correspond to the aluminium fluoride layer 9.

The metal fluoride in the protective layer 13, on irradiation with the VUV radiation 5, reacted with an oxidizing gas in the environment of the mirror 1, for example with O₂, or possibly with O₃, H₂O, N₂O, O*, OH*, NO*, O (¹D), etc., and formed a metal oxide. In addition, at the surface 3 that forms the interface between the protective layer 13 and the aluminium substrate 2, aluminium was also converted to aluminium oxide (Al₂O₃), as indicated in FIG. 5B. As likewise indicated in FIG. 5B, colour centres 14 are formed in the protective layer 13 on irradiation with the VUV radiation 5.

Both the conversion of the metal fluoride in the protective layer 13 to a metal oxide and the formation of the colour centres 14, and the oxidation of the metallic aluminium at the surface 3 to Al₂O₃, result in a distinct reduction in reflectivity of the mirror 1.

The mirror 1 shown in FIG. 5B is therefore subjected to a treatment using a fluorine plasma jet 7, as shown in FIG. 6A. The mirror 1, or more specifically the protective layer 13, is irradiated in a process chamber which is not shown in FIG. 6A. The process chamber or the plasma coating system may be designed as described above in association with FIG. 2A.

The power of the plasma source 8 and other plasma parameters are adjusted such that the following chemical reactions proceed in the protective layer 13 or at the surface 3:

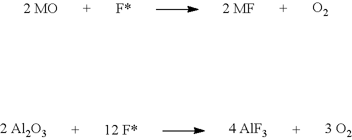

In the above reaction equations, MO denotes a metal oxide and MF a metal fluoride. As apparent from the reaction equations, the reaction with fluorine species F* results in refluorination of the protective layer 13 in that the metal oxide MO formed is converted to a metal fluoride MF. The treatment with the fluorine plasma jet 7 also converts aluminium oxide formed at the aluminium surface 3 to aluminium fluoride, which likewise leads to an increase in reflectivity.

The treatment with the fluorine plasma jet 7 additionally eliminates the colour centres 14, as apparent in FIG. 6B. These above-described processes lead to an increase in the VUV reflectance of the mirror 1 to up to 80%, and to an increase in lifetime of the mirror 1.

The mirror 1 that has been treated in the manner described above can be used in different optical arrangements for the VUV wavelength range.

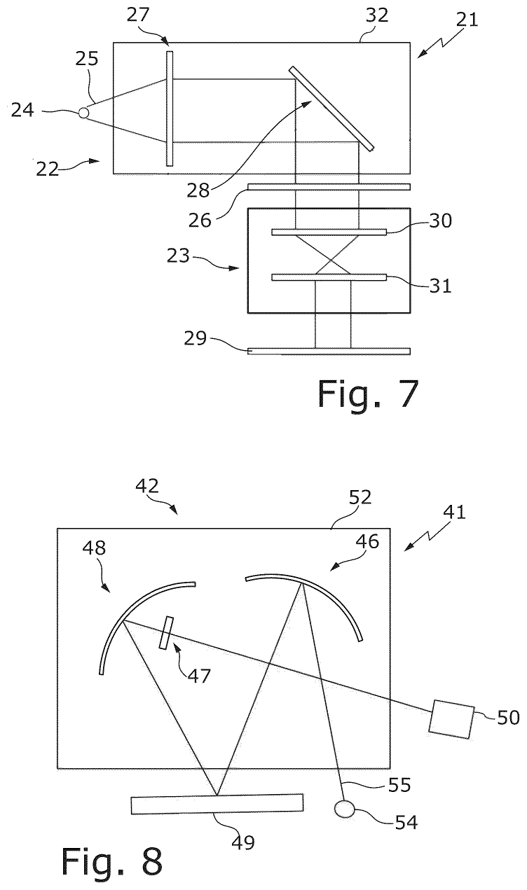

FIG. 7 shows an optical arrangement for the VUV wavelength range in the form of a VUV lithography apparatus 21. The VUV lithography apparatus 21 comprises two optical systems, namely an illumination system 22 and a projection system 23. The VUV lithography apparatus 21 additionally has a radiation source 24, which can be an excimer laser, for example.

The radiation 25 emitted by the radiation source 24 is conditioned with the aid of the illumination system 22 such that a mask 26, also called a reticle, is illuminated thereby. In the example shown, the illumination system 22 has a housing 32, in which there are disposed both transmissive and reflective optical elements. In a representative manner, the illustration shows a transmissive optical element 27, which focuses the radiation 25, and a reflective optical element 28, which deflects the radiation.

The mask 26 has, on its surface, a structure which is transferred to an optical element 29 to be exposed, for example a wafer, with the aid of the projection system 23 for the purpose of producing semiconductor components. In the example shown, the mask 26 is designed as a transmissive optical element. In alternative embodiments, the mask 26 can also be designed as a reflective optical element.

The projection system 22 has at least one transmissive optical element in the example shown. The example shown illustrates, in a representative manner, two transmissive optical elements 30, 31, which serve, for example, to reduce the structures on the mask 26 to the size desired for the exposure of the wafer 29.

Both in the illumination system 22 and in the projection system 23, a wide variety of transmissive, reflective or other optical elements can be combined with one another as desired, including in a more complex manner. Optical arrangements without transmissive optical elements can also be used for VUV lithography.

FIG. 8 shows an optical arrangement for the VUV wavelength range in the form of a wafer inspection system 41, but it may also be a mask inspection system. The wafer inspection system 41 has an optical system 42 with a radiation source 54, from which radiation 55 is directed onto a wafer 49 via the optical system 42. For this purpose, the radiation 55 is reflected onto the wafer 49 by a concave mirror 46. In the case of a mask inspection system, it would be possible to replace the wafer 49 with a mask to be examined. The radiation reflected, diffracted and/or refracted by the wafer 49 is directed onto a detector 50 for further evaluation by a further concave mirror 48, which is likewise associated with the optical system 42, via a transmissive optical element 47. The wafer inspection system 41 additionally has a housing 52, in which there are disposed the two mirrors 46, 48 and the transmissive optical element 47. The radiation source 54 may, for example, be exactly one radiation source or a combination of a plurality of individual radiation sources in order to provide a substantially continuous radiation spectrum. In modifications, one or more narrowband radiation sources 54 can also be used.

At least one reflective optical element 28 of the VUV lithography apparatus 21 shown in FIG. 7 and at least one of the reflective optical elements 46, 48 of the wafer inspection system 41 shown in FIG. 8 may have been treated in the manner described above and irradiated using a fluorine plasma jet 7. In particular, at least one of the reflective optical elements 28, 46, 48 may have a protective layer 13 in the form of a metal fluoride layer that has been post-fluorinated using the method described in association with FIGS. 6A-6B

What is claimed is:

1. A method of treating a reflective optical element for the VUV wavelength range, the reflective optical element comprising an aluminium surface, the method comprising:
irradiating the reflective optical element with a hydrogen plasma jet to remove an aluminium oxide layer formed on the aluminium surface, thereby forming an exposed aluminium surface; and
after removing the aluminium oxide layer, irradiating the exposed aluminium surface with a fluorine plasma jet.

2. The method of claim 1, wherein the hydrogen plasma jet comprises at least one gas selected from the group consisting of N₂ and Ar.

3. The method of claim 1, wherein irradiating the exposed aluminium surface with the fluorine plasma jet forms an aluminium fluoride layer on the aluminium surface.

4. The method of claim 3, further comprising, before forming the aluminium fluoride layer on the aluminium surface, removing a protective layer applied to the aluminium surface.

5. The method of claim 4, wherein the protective layer comprises a material that reacts with fluorine to provide a volatile fluorine species.

6. The method of claim 4, wherein the protective layer comprises silicon or carbon.

7. The method of claim 4, comprising using the fluorine plasma jet to remove the protective layer.

8. The method of claim 1, wherein a protective layer comprising a metal fluoride is supported by the aluminium surface, and the method further comprises irradiating the protective layer with the fluorine plasma jet for post-fluorination.

9. The method of claim 1, further comprising, before irradiating the reflective optical element with the hydrogen plasma jet to remove the aluminium oxide layer formed on the aluminium surface, irradiating the reflective optical element with VUV radiation.

10. The method of claim 1, wherein:
irradiating with the hydrogen plasma jet comprises moving the hydrogen plasma jet across the aluminium surface; and/or
irradiating with the fluorine plasma jet comprises moving the plasma jet across the aluminium surface.

11. The method of claim 1, wherein irradiating with the hydrogen plasma jet and irradiating with the fluorine plasma jet are done under vacuum conditions.

12. The method of claim 1, wherein the fluorine plasma jet comprises at least one member selected from the group consisting of CF₄, CHF₃, C₂F₆, NF₃, SF₆ and F₂.

13. The method of claim 1, wherein the fluorine plasma jet comprises a carrier gas.

14. A method of treating a reflective optical element for the VUV wavelength range, the reflective optical element comprising an aluminium surface, the method comprising:
irradiating the reflective optical element with a fluorine plasma jet.

15. The method of claim 14, wherein the method comprises irradiating the aluminium surface with the plasma jet.

16. The method of claim 15, wherein irradiating the aluminium surface with the fluorine plasma jet forms an aluminium fluoride layer on the aluminium surface.

17. The method of claim 16, further comprising, before forming the aluminium fluoride layer on the aluminium surface, removing a protective layer applied to the aluminium surface.

18. The method of claim 14, wherein irradiating the reflective optical element with the fluorine plasma jet removes an aluminium oxide layer formed on the aluminium surface.

19. The method of claim 14, wherein:
irradiating the reflective optical element with the fluorine plasma jet removes an aluminium oxide layer formed on the aluminium surface, thereby forming an exposed aluminium surface;
the method further comprises, after removing the aluminium oxide layer, irradiating the exposed aluminium surface with a fluorine plasma jet.

20. The method of claim 19, further comprising, before forming the aluminium fluoride layer on the aluminium surface, removing a protective layer applied to the aluminium surface.
